(19) United States
(12) Patent Application Publication
(10) Pub. No.: US 2004/0114562 A1
(43) Pub. Date: Jun. 17, 2004

(54) Wireless LAN communication control method

(75) Inventor: Tae-Kon Kim, Seongnam-city (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/721,380

(22) Filed: Nov. 26, 2003

(30) Foreign Application Priority Data
Nov. 29, 2002 (KR) 10-2002-0075546

(51) Int. Cl. H04Q 7/24

(52) U.S. Cl. 370/338; 370/447

(57) ABSTRACT

A wireless LAN communication control method includes (a) verifying whether data remains in a queue of a Point Coordinator (PC) after a Contention-Free Period (CFP) is terminated; and (b) transmitting the data remaining in the queue of the PC in advance, i.e., before entering a contention mode, in a case that the data remains in the queue as a result of the verification. Accordingly, the data sent from each station to the PC is preferentially transmitted to a destination station without contentions so that an overall system performance is improved.

### CROSS-REFERENCE TO RELATED APPLICATIONS

This application claims the benefit of Korean Patent Application No. 10-2002-0075546 filed Nov. 29, 2002 in the Korean Intellectual Property Office, the disclosure of which is incorporated herein by reference.

### BACKGROUND OF THE INVENTION

1. Field of the Invention

The present invention relates to a communication control method for a wireless LAN communication system, and more particularly, to a wireless LAN communication control method in the infrastructure mode.

2. Description of the Related Art

The IEEE 802.11 wireless LAN Committee has proposed a specification for transmitting data in the wireless manner in local area environments, and commercial wireless LAN products are currently used. In view of current trends that users search and use information while moving instead of using information while staying at one place, such a wireless LAN technology would be used in primary communication environments.

The Medium Access Control (MAC) of the 802.11 standard defines two types of medium access modes. The first medium access mode is the Distributed Coordination Function (DCF) mode, and the second medium access mode is the Point Coordination Function (PCF) mode. The DCF mode is an asynchronous data transfer mode based on the Carrier Sense Multiple Access with Collision Avoidance (CSMA/CA) protocol, wherein stations verify whether a wireless medium is idle, contend with one another, obtain access to the medium, and send data.

FIG. 1 is a view for showing basic operation procedures for the DCF mode.

The DCF mode is an asynchronous data transfer method and is used when sending data insensitive to time delays, and only the DCF mode is used for ad-hoc networks, i.e., in an ad-hoc mode. The DCF can be used alone or together with the PCF for an infrastructure network, i.e., in the infrastructure mode. The stations in a Basic Service Set (BSS) operating under the DCF mode have the same priority to obtain medium access through contentions. That is, every station sends data after obtaining access to the medium through contentions before data transmissions.

As shown in FIG. 1, a station to send data defers its access to the medium as long as a different station occupies the medium, detects that the medium is idle for a Distributed Inter-Frame Space (DIFS) period when the different station completes its use of the medium, generates a random Backoff time to avoid colliding with the other stations waiting for data transmissions, and sends data when the Backoff time is decremented to zero. At this time, the other station waiting for data transmission does not obtain access to use the meidum since the Backoff time is not yet decremented to zero.

In the meantime, the PCF mode is a mode taking into consideration data requiring Quality of Service (QoS), and is controlled by a Point Coordinator (PC), in which the PC provides each station with scheduled access to the medium by using a polling scheme, rather than providing for stations to obtain access to the medium through each other's contentions.

FIG. 2 is a view for explaining the PCF mode, especially for explaining the Contention-Free Period/Contention Period (CFP/CP) alternations. Referring to FIG. 2, the PCF mode is a mode used for an infrastructure network, and, basically, controlled by the polling scheme of the PC existing in an Access Point (AP). As shown in FIG. 2, a PCF control frame is used for a Contention-Free Period (CFP), and the CFP can be used together with a Contention Period (CP) operating in the same way as the DCF mode. The CFP of the PCF mode starts from a beacon frame, and basically operates by the polling scheme controlled by the Point Coordinator (PC) in the Access Point (AP) of the Basic Service Set (BSS) for the CFP. The PC controls during the entire CFP as the CFP starts. Its control method uses a Point Coordination Inter Frame Space (PCF IFS, or PIFS) period with a time interval shorter than the DIFS used in the DCF mode. As the CFP starts, all the stations in the BSS set the Network Allocation Vector (NAV) to as long a period of time as the CFP so that medium access contention is avoided.

However, in processing data in the PCF or DCF manner in the IEEE 802.11 infrastructure mode, the data sent from a station is transmitted to the PC all the time, and then processed by the PC itself or sent to a destination station by the PC. Various papers have proposed methods to improve wireless LAN performance, and have also evaluated the performance of these proposed methods. The performance evaluations and improvements for the DCF mode have been discussed in the DCF+ method of Haita Wu and other materials. As for the PCF mode, Jing-Yuan Yuh has evaluated the performances by proposing the polling schemes of Round-Robin, First-in First-out, and the like, and such discussions have been made in many other materials as well.

However, when evaluating the performances in the above methods, the methods have evaluated the performances assuming that data transmissions are completed when data is sent from a station to the Point Coordinator (PC), rather than assuming that data transmissions are completed when the data sent from a source station is transmitted to a destination station. A problem in this case is an increased possibility that data remaining in a queue of the PC previously formed is not transmitted but continuously stays in the queue, since the PC and stations participate in medium contention in the same level in the DCF mode after the termination of the medium Contention-Free Period (CFP) operating under the controls of the PC in the PCF mode. In this case, when data is not sent to the destination station due to overtime, transmission error, and so on, another problem occurs in that the aforementioned performance evaluations are not appropriate for the entire performance evaluations, in addition to the possibility that the queue of the PC becomes insufficient over time.

In particular, all the data transmissions are to be done via the Access Point (AP) in the infrastructure mode. Therefore, lots of data has to be buffered at the AP in general. Further, when data is sent from a station in the peer-to-peer manner, the AP has to transmit its buffering data to a destination station during the PCF mode or DCF mode. However, if the AP fails to send all the data during the PCF mode, the AP has to attempt to transmit the data during the DCF mode. During the DCF mode, the AP has to gain access to the medium through a contention procedure. Accordingly, the possibility for the data to not be transmitted, and thus remain in the queue, becomes higher. Further, it is highly possible that the non-transmitted data remains in the queue for a long time so as to become useless due to its aging. Worse situations can arise due to the above cases as more data communications are performed in a system.

### SUMMARY

The present invention has been devised to solve the above problems, so it is an exemplary aspect of the present invention to provide a communication control method for a wireless LAN in the infrastructure mode, capable of improving an overall system performance wherein data sent from each station to a PC can be preferentially transmitted to a corresponding destination station without medium contentions.

In order to achieve the above exemplary aspect, in a wireless LAN communication control method, the communication control method according to the present invention comprises steps of (a) verifying whether data remains in a queue of a Point Coordinator (PC) after a Contention-Free Period (CFP) is terminated; and (b) transmitting the data remaining in the queue of the PC in advance before entering a contention mode in the case that the verification result indicates that the data remains in the queue.

The step (b) includes the steps of waiting for a predetermined period of time; transmitting the data; and verifying a response signal to the data transmission.

Further, the response signal verification step includes the steps of waiting for an arrival of the response signal for a predetermined period of timeout; and retrying the data transmissions repeatedly in a case that no response signal arrives.

The predetermined period of time is a PIFS (PCF IFS) time.

### BRIEF DESCRIPTION OF THE DRAWINGS

The above exemplary aspect and other exemplary features of the present invention will become more apparent by describing in detail an illustrative, non-limiting embodiment thereof with reference to the attached drawings, and wherein:

FIG. 1 is a view for showing basic operation procedures for the DCF mode;

FIG. 2 is a view for explaining the PCF mode;

FIG. 3 is a flow chart for explaining an Extended PCF (EPCF) mode according to an embodiment of the present invention;

FIG. 4 is a view for explaining correlations among the CFP, EPCF, and CP;

FIG. 5 is a view for showing a result of simulations for the overall performances of a system in the DCF mode and in a mode combined with the EPCF;

FIG. 6 is a view for showing a result of measurements of maximum buffer amounts required in a PC in the DCF mode and in the EPCF mode; and

FIG. 7 is a view for showing performance comparisons for an entire system upon the peer-to-peer transmission in an occasion of limiting the buffer of the PC.

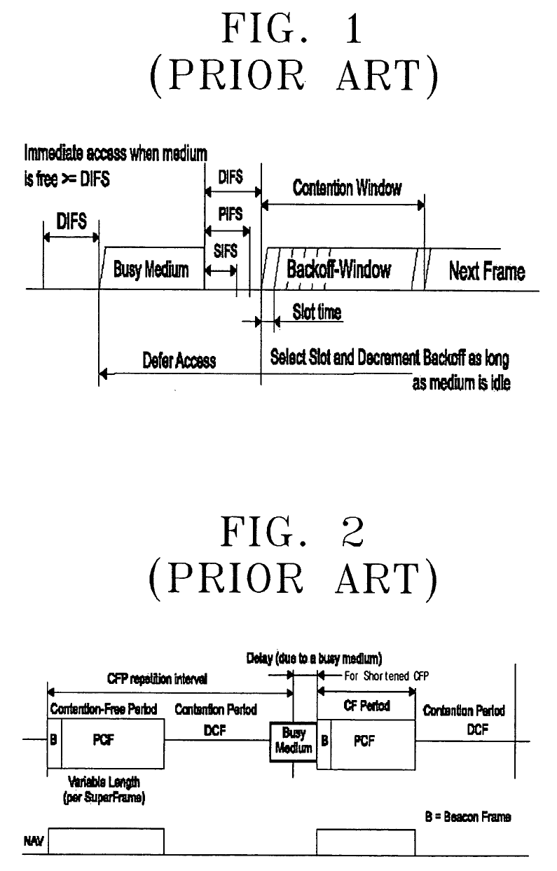

### DETAILED DESCRIPTION OF THE PREFERRED EMBODIMENT

Hereinafter, the present invention will be described in detail with reference to the attached drawings.

The Point Coordinator (PC) operates in the contention mode when the Contention-Free Period (CFP) is terminated in the PCF mode. At this time, the PC operates in the same way as in the DCF mode. If there is data remaining in the queue of the PC when in the contention mode, the PC obtains access to the medium through contentions with other stations, and then sends data.

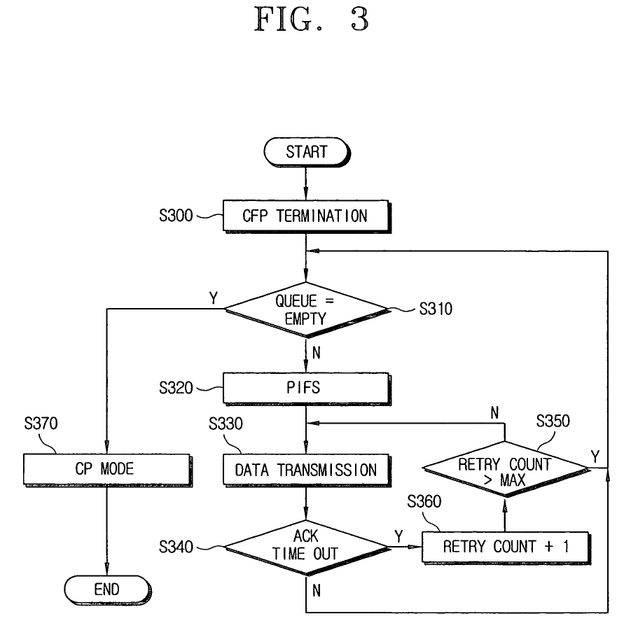

FIG. 3 is a flow chart for explaining the operation procedures of the method according to an illustrative embodiment of the present invention. The method used for the present invention is referred to as “Extended PCF” (EPCF). Referring to the flow chart of FIG. 3, the EPCF transmits data during the CFP in a manner of the round-robin (RR), FIFO-Priority, Priority-ELF (Effort-Limited Fair), or the like, and then, if the CFP is terminated (S300), data may or may not remain in the queue of the PC. At this time, in the existing 802.11 standard, the mode changes into the DCF mode, and stations and the PC compete with one another for access to the medium so that a station or the PC which has obtained access to the medium sends its data. The time required for the medium contention is a period of time for the operations in which it is verified whether the medium is idle after waiting for the DIFS period as in the DCF mode, and then, if a random Backoff time is generated and a different station does not occupy the medium until the Backoff time reaches zero, a station with the Backoff time of 0 obtains the medium. That is, the time needed for obtaining the medium during the DCF mode can be expressed in Equation 1 as follows:

Time needed during the DCF mode=DIFS+Random Backoff time [Equation 1]

However, if the EPCF mode is used and data remains in the queue of the PC (“N” in S310), the PC occupies the medium preferentially in order to empty its queue. At this time, in order for the PC to occupy the medium first, the PC uses the PIFS interval shorter than the DIFS period while other stations wait for the DIFS (S320). By doing so, the queue of the PC can be emptied without any modification applied to the stations compliant to the 802.11a/b standard. At this time, since the medium contention is not needed for the time required for sending data, there is no need for the random Backoff time, but only for the PIFS time. That is, the time needed for data transmissions during the EPCF mode can be expressed in Equation 2 as follows:

Time needed for data transmissions during the EPCF mode=PIFS [Equation 2]

The time difference between the DCF mode and the EPCF mode to send data remaining in the queue of the PC in the Equation 2 can be expressed in Equation 3 as follows:

Time needed during the DCF mode−Time needed during the EPCF mode=DIFS+Random Backoff time−PIFS [Equation 3]

After the PC obtains preferential access to the medium, it transmits data via the medium (S330). Thereafter the PC awaits the arrival of a response signal, for a timeout period, in response to the transmitted data (S340). In the event that the response signal is not received within the timeout period, a retry counter is incremented (S360). As long as the retry counter is less than a predetermined retry value (“N” in S350), the transmission of the data is repeated until a response signal is received within the timeout period.

If there is no more data remaining in the queue of the PC while the PC operates in the EPCF mode (“Y” in S310), the PC waits for the DIFS for data transmissions instead of waiting for the PIFS, so the mode is changed back to the DCF mode (S370). If there is no data remaining in the queue of the PC when the CFP is terminated, the PC operates in the DCF mode rather than in the EPCF mode.

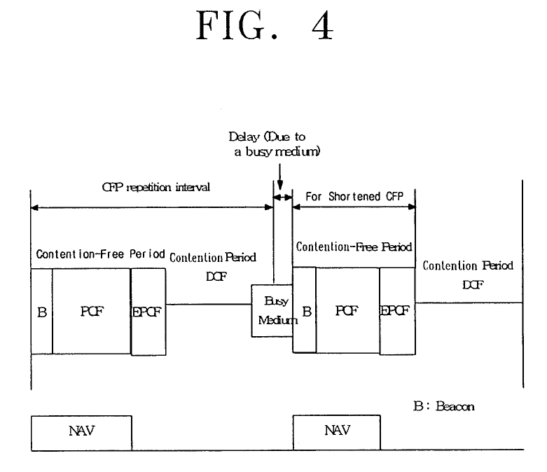

In the event that data remains in the queue of the PC after the CFP is terminated, the present invention uses the EPCF mode for sending the data remaining in the queue of the PC in advance, i.e., before entering the contention mode, to thereby improve the system performance. FIG. 4 is a view for showing correlations among the Contention-Free Period (CFP), Extended PCF (EPCF) mode, and Contention Period (CP).

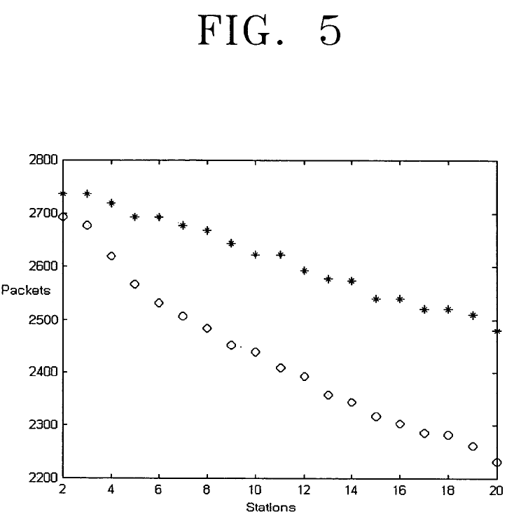

FIG. 5 to FIG. 7 are view for showing experiment results on the method according to the present invention.

The present experiments were carried out under the conditions that the maximum MAC protocol data unit (MPDU) size, i.e., MAX MPDU, was set to 1500 bytes, the Request to Send (RTS) threshold was set to 2000 bytes, the Request to Send/Clear to Send (RTS/CTS) was not used, no fragmentation was assumed, the superframe time was set to 200 msec, and the PCF duration was set to 50 msec. The measurements were carried out several times with the measurement time set to 1 second.

In the present experiments, it was also assumed that data has a constant size of 1500 bytes all the time and its occurrence frequency was 15 Mbps on average. At this time, since the number of data occurring from each station was not constant, data of variable lengths was stored in the queue of the PC after the CFP was terminated. At this time, the number of transmitted packets was measured when the EPCF mode was used and when the DCF mode was used, depending upon the amount of data stored in the queue, for the comparisons of the entire system performance. Table 1 shows parameters used for the experiments.

TABLE 1

| Parameters | Values | | Parameters | Values | |
|---|---|---|---|---|---|
| Physical layer | OFDM | | Preamble | 16 | μsec |
| | | | Duration | | |
| Transmission | 54 | Mbps | PLCP Header | 4 | μsec |
| speed | | | | | |
| Slot Time | 9 | μsec | CW Min | 15 | |
| SIFS Time | 16 | μsec | CW Max | 1023 | |
| PIFS Time | 25 | μsec | ACK size | 14 | Bytes |
| DIFS Time | 34 | μsec | RTS Threshold | 2000 | Bytes |

FIG. 5 is a view for showing simulation results on the entire performance of a system in the DCF mode and in a mode combined with the EPCF mode. In FIG. 5, the mark, o, indicates the use of the DCF mode, and the mark, *, indicates the use of the EPCF mode. The results show that the system performance is improved when the EPCF mode is employed, and even more so as more stations are involved.

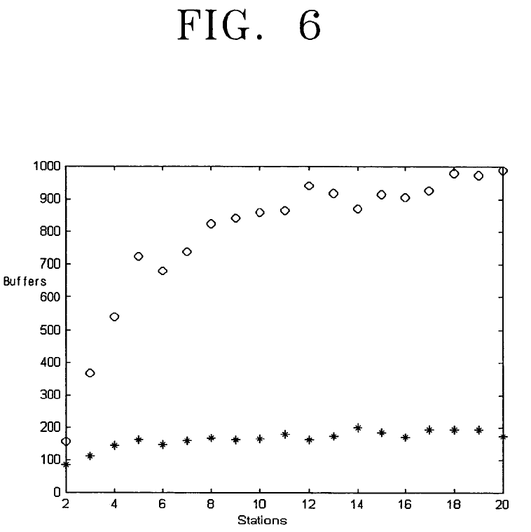

FIG. 6 is a view for showing measurement results on maximum buffer amounts the PC requires in the DCF mode and the EPCF mode. In FIG. 6, the mark, o, indicates the DCF mode, and the mark, *, indicates the EPCF mode. As shown in FIG. 6, the amount of buffers required in the PC continuously increases in the DCF mode, whereas a relatively small amount of buffers is enough during the EPCF mode since data remaining in the queue is preferentially transmitted.

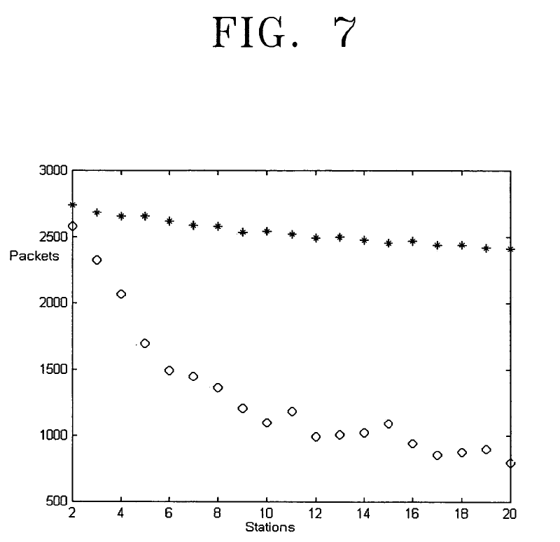

In computing the system performance in general, it is computed that data transmissions are successful when data is sent from a station to the PC. However, the present invention decides that the data transmissions are failed when the data received in the PC is not transmitted to a destination station due to the buffer limitation, and does not apply such failed data transmissions to the system performance computation. FIG. 7 shows a system performance when the failed data transmissions are not applied to the system performance computation. FIG. 7 is a view for showing measurement results when the number of buffers in the PC is limited to 300 wherein the mark, o, indicates the DCF mode and the mark, *, indicates the EPCF mode.

The present invention proposes the EPCF interval for which the Access Point (AP) can transmit data in the infrastructure mode free of medium contentions with other stations, and the experiment results are as follows. That is, first, the results show that the system performance is improved compared to the DCF mode. The results show that the system has a better performance as there is more data stored in the queue of the PC. In the worst case, the present invention has the same result as the 802.11 standard. Second, the present invention reduces the number of buffers required in the PC. The present invention sends all the data stored in the queue during the EPCF mode with priority, to thereby prevent the occasions that require more buffers by receiving data from other stations and storing the data in the queue of the PC when the PC does not obtain access to the medium during the Contention Period (CP), as more stations are involved. Third, the present invention improves the peer-to-peer transmission rate. In general, only a path from a station to the PC is considered when the performance is evaluated in the 802.11 standard. However, in the case of using the EPCF mode, the peer-to-peer transmission probability increases, without the occasions of data being discarded or such due to insufficient buffers, since the data sent to the PC is preferentially transmitted during the Contention-Free Period (CFP). Lastly, the EPCF mode according to the present invention can be used together with the 802.11 a/b stations currently commercialized in algorithms operating in the PC without modifications of the 802.11 a/b stations.

As described above, according to the present invention, the data sent from each station to the PC is preferentially transferred to a destination station without contentions so that the overall system performance is improved. Further, the present invention requires the modifications of the PC only, so that there is no need to modify the stations compliant to the IEEE 802.11 standard.

An illustrative embodiment of the present invention has been described, and it will be understood by those skilled in the art that the present invention should not be limited to the described embodiment, but various changes and modifications can be made within the spirit and scope of the present invention as defined by the appended claims.

What is claimed is:

1. A wireless LAN communication control method, comprising:
verifying whether data remains in a queue of a point coordinator (PC) after a contention-free period (CFP) is terminated; and
if a result of the verification indicates that data remains in the queue, transmitting the data remaining in the queue of the PC before entering a contention mode.

2. The wireless LAN communication control method as claimed in claim 1, further comprising if the result of the verification indicates that no data remains in the queue, entering the contention mode.

3. The wireless LAN communication control method as claimed in claim 1, wherein the data transmission operation obtains a preferential access to a medium and transmits data while one or more stations wait for use of the medium.

4. The wireless LAN communication control method as claimed in claim 3, wherein the data transmission operation includes:
obtaining preferential access to the medium after a predetermined period of time;
transmitting the data via the medium; and
verifying a response signal to the data transmission.

5. The wireless LAN communication control method as claimed in claim 4, wherein the predetermined period of time is shorter than a DIFS time period for verifying whether the medium is idle.

6. The wireless LAN communication control method as claimed in claim 4, wherein the response signal verification operation includes:
waiting for an arrival of the response signal for a predetermined period of timeout; and
retrying the data transmission if the response signal fails to arrive with the predetermined period of timeout.

7. The wireless LAN communication control method as claimed in claim 6, wherein the operations of waiting for the arrival of the response signal and retrying the data transmission are repeated for a predetermined number of attempts.
